(19) United States
(12) Patent Application Publication
(10) Pub. No.: US 2010/0329450 A1
(43) Pub. Date: Dec. 30, 2010

(54) INSTRUCTIONS FOR PERFORMING DATA ENCRYPTION STANDARD (DES) COMPUTATIONS USING GENERAL-PURPOSE REGISTERS

(75) Inventors: Leonard D. Rarick, San Jose, CA (US); Christopher H. Olson, Austin, TX (US); Gregory F. Grohoski, Bee Cave, TX (US)

Correspondence Address: PVF -- ORACLE AMERICA, INC.;C/O PARK, VAUGHAN & FLEMING LLP, 2820 FIFTH STREET, DAVIS, CA, 95618-7759, US

(73) Assignee: SUN MICROSYSTEMS, INC., Santa Clara, CA (US)

(21) Appl. No.: 12/494,481

(22) Filed: Jun. 30, 2009

(51) Int. Cl. H04L 9/06

(52) U.S. Cl. 380/29

(57) ABSTRACT

Some embodiments of the present invention provide a processor, which includes a set of general-purpose registers and at least one execution unit. Each general-purpose register in the set of general-purpose registers is at least 64 bits wide, and the execution unit supports one or more Data Encryption Standard (DES) instructions. Specifically, the execution unit may support a permutation-rotation instruction for performing DES permutation operations and DES rotation operations. The execution unit may also support a round instruction to perform a DES round operation. Since the DES instructions use general-purpose registers instead of special-purpose registers to perform DES-specific operations, the processor's circuit complexity and area are reduced. Furthermore, in some embodiments, since the DES instructions require at most two operands, the number of bits required to specify the location of the operands are reduced, thereby enabling a larger number of instructions to be supported by the processor.

### RELATED APPLICATION

The subject matter of this application is related to the subject matter of U.S. application Ser. No. 12/414,755 entitled “Apparatus and Method for Implementing Instruction Support for the Data Encryption Standard (DES) Algorithm,” by inventors Christopher H. Olson, Gregory F. Grohoski, and Lawrence A. Spracklen, which was filed on 31 Mar. 2009, and which is hereby incorporated by reference to provide details of the Data Encryption Standard.

### BACKGROUND

1. Technical Field

This disclosure generally relates to processors. More specifically, this disclosure relates to a processor which supports instructions for performing Data Encryption Standard (DES) computations using general-purpose registers.

2. Related Art

Cryptography (i.e., the encoding and decoding of data) enables data to be stored and/or transmitted in a secure manner. Secure communication is typically done by using an encryption process to encode plaintext (i.e., readable data) into ciphertext (i.e., encrypted data), transmitting the ciphertext to a recipient, and using a decryption process to decode the ciphertext back into the readable plaintext.

The Data Encryption Standard (DES) is a block cipher that was selected by the National Bureau of Standards as an official Federal Information Processing Standard (FIPS) for the United States in 1976. Secure communication using DES involves generating/obtaining key data, using the key data and the DES encryption process to encode plaintext into ciphertext, transmitting the ciphertext to a recipient, and using the same key data and the DES decryption process to decode the ciphertext back into readable plaintext.

The DES encryption/decryption process is conventionally performed using either software routines that use the standard logical and arithmetic instructions, adjunct dedicated hardware (e.g., a dedicated cryptographic processor that communicates with the primary processor), or cryptographic hardware capabilities included in a processor that uses special-purpose registers to hold the text and key data.

Unfortunately, conventional approaches for performing DES encryption/decryption have serious drawbacks. Specifically, conventional approaches either increase the processing time needed to perform DES encryption/decryption (e.g., by using software routines), or substantially increase the cost of the system (e.g., by using a dedicated cryptographic processor), and/or substantially increase the design complexity, the chip area, and/or the verification cost for implementing the processor (e.g., because of the special-purpose registers and the data paths needed to use them).

Hence, what are needed are techniques and systems to perform DES encryption and decryption operations without the above-described problems.

### SUMMARY

Some embodiments of the present invention provide techniques and systems for supporting DES-specific permutation, rotation, and/or round instructions for encrypting and/or decrypting data in accordance with the DES encryption/decryption process. In some embodiments, an execution unit, e.g., an ALU (Arithmetic Logic Unit), of a general-purpose processor can be modified to include logic that performs various permutation, rotation, and round operations that are required in DES encryption and decryption processes. A general-purpose processor can include, but is not limited to, a single-threaded processor, a multi-threaded processor, a processor that does not support out-of-order execution, or a processor that supports out-of-order execution.

Specifically, some embodiments of the present invention provide a processor, which includes a set of general-purpose registers and at least one execution unit. Each general-purpose register in the set of general-purpose registers is at least 64 bits wide, and the execution unit supports at least a round instruction to perform a DES round operation. The round instruction can include an opcode which indicates that a DES round operation is desired to be performed, a first operand identifier which specifies a general-purpose register where the DES round operation's text input is stored, a second operand identifier which specifies a general-purpose register where the DES round operation's key input is stored, and a destination identifier which specifies a general-purpose register where the DES round operation's output is to be stored. Note that the above-described round instruction is a two-operand instruction.

The DES round operation can be performed using the following sub-operations: an expand operation and a permutation operation, an exclusive-OR operation, a look-up table operation, another permutation operation, and another exclusive-OR operation and a concatenation operation.

Further, in some embodiments, the execution unit also supports a permutation-rotation instruction for performing DES permutation operations and DES rotation operations. The permutation-rotation instruction can include an opcode which indicates that a DES permutation or rotation operation is desired to be performed, a permutation-rotation identifier which specifies which DES permutation or rotation is desired to be performed, an operand identifier which specifies a general-purpose register where the DES permutation or rotation operation's input is stored, and a destination identifier which specifies a general-purpose register where the DES permutation or rotation operation's output is to be stored. Note that the above-described permutation-rotation instruction is a single-operand instruction.

The permutation-rotation identifier can indicate that one of the following DES permutations is desired to be performed: an initial permutation, a key permutation for encryption, a key permutation for decryption, or a final permutation. The permutation-rotation identifier can also indicate that one of the following DES rotations is desired to be performed: a rotation by one to the left, a rotation by two to the left, a rotation by one to the right, or a rotation by two to the right.

Note that, the processor's circuit complexity and area are reduced because the round instruction and the permutation-rotation instruction use general-purpose registers instead of special-purpose registers to perform DES-specific operations. Further, note that, since the round instruction and the permutation-rotation instruction require at most two operands, the number of bits required to specify the location of the operands are reduced, thereby enabling a larger number of instructions to be supported by the processor.

In some embodiments, the execution unit may support two separate instructions for performing permutations and rotations: a permutation instruction for performing DES permutations, and a rotation instruction for performing DES rotations.

Further, in some embodiments, the round instruction is a three-operand instruction. This round instruction can include an opcode which indicates that two DES round operations are desired to be performed, a first operand identifier which specifies a general-purpose register where the text input for the two DES round operations is stored, a second operand identifier which specifies a general-purpose register where the key input for the first of the two DES round operations is stored, a third operand identifier which specifies a general-purpose register where the key for the second of the two DES round operations is stored, and a destination identifier which specifies a general-purpose register where the DES round operation's output is to be stored.

Some embodiments of the present invention provide techniques and systems for performing DES encryption and decryption using a processor that supports a permutation-rotation instruction and a round instruction.

Specifically, a system can use the processor to perform DES encryption by: executing a permutation-rotation instruction to perform a DES initial permutation operation; executing a permutation-rotation instruction to perform a DES key permutation operation for encryption; executing two iterations of: a round instruction and a permutation-rotation instruction to perform a rotation by one to the left; executing six iterations of: a round instruction and a permutation-rotation instruction to perform a rotation by two to the left; executing one iteration of: a round instruction and a permutation-rotation instruction to perform a rotation by one to the left; executing six iterations of: a round instruction and a permutation-rotation instruction to perform a rotation by two to the left; executing a round instruction; and executing a permutation-rotation instruction to perform a DES final permutation.

Further, the system can use the processor to perform DES decryption by: executing a permutation-rotation instruction to perform a DES initial permutation operation; executing a permutation-rotation instruction to perform a DES key permutation operation for decryption; executing two iterations of: a round instruction and a permutation-rotation instruction to perform a rotation by one to the right; executing six iterations of: a round instruction and a permutation-rotation instruction to perform a rotation by two to the right; executing one iteration of: a round instruction and a permutation-rotation instruction to perform a rotation by one to the right; executing six iterations of: a round instruction and a permutation-rotation instruction to perform a rotation by two to the right; executing a round instruction; and executing a permutation-rotation instruction to perform a DES final permutation.

### BRIEF DESCRIPTION OF THE FIGURES

FIG. 1 illustrates a multi-threaded processor in accordance with an embodiment of the present invention.

FIG. 2 illustrates a processor core in accordance with an embodiment of the present invention.

FIG. 3 illustrates a computer system in accordance with an embodiment of the present invention.

FIG. 4A presents a flowchart that illustrates the overall structure of the DES encryption/decryption process.

FIG. 4B presents a flowchart that illustrates how the “F” operation can be performed on half a block.

FIG. 4C presents a flowchart that illustrates how the subkeys for each of the 16 DES rounds can be derived from the main key according to the key schedule.

FIG. 5 illustrates an exemplary format for a permutation-rotation instruction and a round instruction in accordance with an embodiment of the present invention.

FIG. 6 illustrates a block diagram for a circuit which can be used to support a permutation-rotation instruction which uses general-purpose registers in accordance with an embodiment of the present invention.

FIG. 7 illustrates a block diagram for a circuit which can be used to perform rotation operations in accordance with an embodiment of the present invention.

FIG. 8 illustrates a block diagram for a circuit which can be used to perform round operations in accordance with an embodiment of the present invention.

FIG. 9 illustrates a circuit which uses logic gates (instead of a read-only memory) to implement the S-BOX look-up tables in accordance with an embodiment of the present invention.

FIG. 10 presents a flowchart that illustrates a process for performing DES encryption using permutation-rotation instructions and round instructions in accordance with an embodiment of the present invention.

FIG. 11 presents a flowchart that illustrates a process for performing DES decryption using permutation-rotation instructions and round instructions in accordance with an embodiment of the present invention.

FIG. 12 illustrates the contents of the registers that are required at the beginning of the DES computation in Burke's system.

FIGS. 13A-13C illustrate a series of instructions that are required to perform the round operation in Burke's system.

Table 1 illustrates how the DES encryption process may be divided into 34 separate and discrete operations in accordance with an embodiment of the present invention.

### DETAILED DESCRIPTION

The following description is presented to enable any person skilled in the art to make and use the embodiments. Various modifications to the disclosed embodiments will be readily apparent to those skilled in the art, and the general principles defined herein are applicable to other embodiments and applications without departing from the spirit and scope of the present disclosure. Thus, the present invention is not limited to the embodiments shown, but is to be accorded the widest scope consistent with the principles and features disclosed herein.

The data structures and code described in this disclosure can be partially or fully stored on a computer-readable storage medium and/or a hardware module and/or hardware apparatus. A computer-readable storage medium includes, but is not limited to, volatile memory, non-volatile memory, magnetic and optical storage devices such as disk drives, magnetic tape, CDs (compact discs), DVDs (digital versatile discs or digital video discs), or other media, now known or later developed, that are capable of storing code and/or data. Hardware modules or apparatuses described in this disclosure include, but are not limited to, application-specific integrated circuits (ASICs), field-programmable gate arrays (FPGAs), dedicated or shared processors, and/or other hardware modules or apparatuses now known or later developed.

The methods and processes described in this disclosure can be partially or fully embodied as code and/or data stored in a computer-readable storage medium or device, so that when a computer system executes the code and/or reads the data, the computer system performs the associated methods and processes. The methods and processes can also be partially or fully embodied in hardware modules or apparatuses, so that when the hardware modules or apparatuses are activated, they perform the associated methods and processes. Note that the methods and processes can be embodied using a combination of code, data, and hardware modules or apparatuses.

### Processor and Computer System

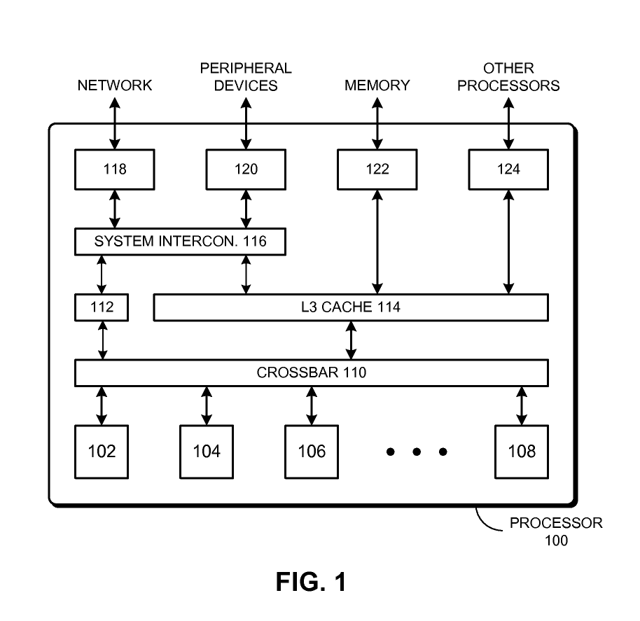

FIG. 1 illustrates a multi-threaded processor in accordance with an embodiment of the present invention.

Processor 100 can include multiple cores, such as, cores 102, 104, 106, and 108. Each core can have an L2 cache (not shown). Processor 100 can include communication mechanisms for enabling different components of processor 100 to communication with one another. For example, processor 100 can include crossbar 110 and system interconnect 116 to enable communication between different components in the processor. Specifically, cores 102, 104, 106, and 108 can be coupled to various internal and external components via crossbar 110. For example, the cores can be coupled to the system memory via crossbar 110, L3 cache 114, and memory interface 122. Similarly, the cores can be coupled to other processors in the system via crossbar 110, L3 cache 114, and processor interface 124. The cores can also be coupled to peripheral devices via crossbar 110, non-cacheable unit 112, system interconnect 116, and peripheral interface 120. Further, the cores can be coupled to the network via crossbar 110, non-cacheable unit 112, system interconnect 116, and network interface 118.

A core may be configured to execute instructions according to a particular instruction set architecture (ISA). Specifically, a core may be configured to execute instructions that are specifically designed to improve performance for encrypting and decrypting data according to DES. Further, each core may execute multiple threads concurrently, and a core may execute instructions of a thread in an out-of-order fashion. The processor illustrated in FIG. 1 is for illustration purposes only and is not intended to limit embodiments of the present invention to the forms disclosed. Specifically, an embodiment of the present invention may be incorporated in a single-core processor that does not support multiple hardware threads.

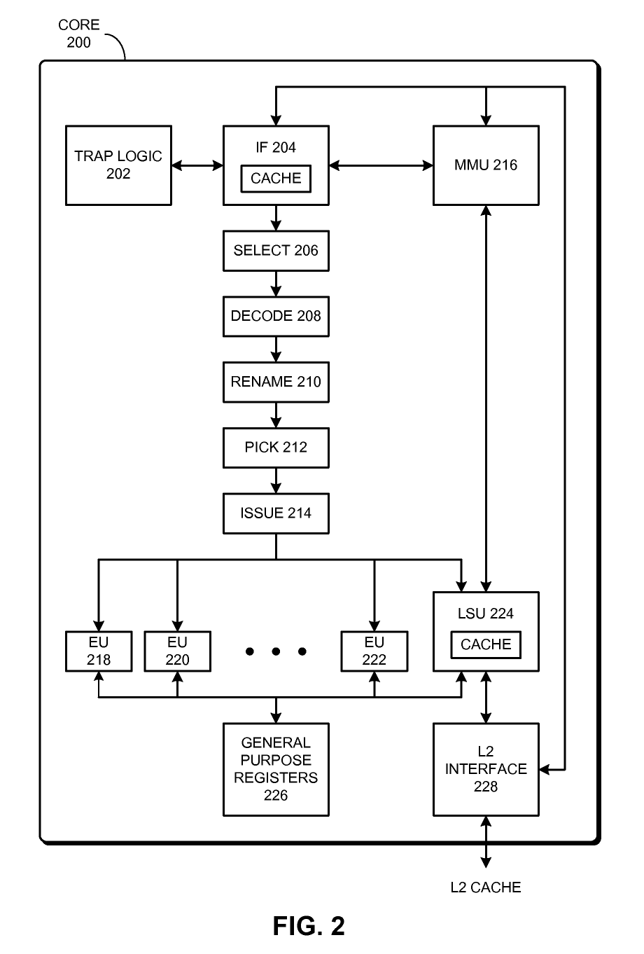

FIG. 2 illustrates a processor core in accordance with an embodiment of the present invention.

Core 200 can include instruction fetch unit (IFU) 204 which can include an instruction cache. IFU 204 can be coupled to memory management unit (MMU) 216 and trap logic unit 202. IFU 204 can also be coupled to an instruction pipeline which includes select unit 206, decode unit 208, rename unit 210, pick unit 212, and issue unit 214. Issue unit 214 can issue an instruction on an execution unit, such as, execution units 218, 220, and 222. Issue unit 214 may issue load and store instructions to a specialized execution unit, such as load store unit (LSU) 224, which may include a data cache. The core may also include other specialized execution units, such as, a floating point unit or a graphics processing unit (not shown). All execution units (including any specialized execution units) may be coupled to general-purpose registers 226 to enable the execution units to manipulate data stored in the registers. LSU 224 can be coupled to MMU 216 and to L2 interface unit 228 to access the L2 cache.

IFU 204 can select a thread, and fetch instructions associated with the selected thread for processing via the instruction pipeline. Select unit 206 can select a ready thread, and schedule one or more instructions associated with that thread for execution. Decode unit 208 can decode the scheduled instructions to determine the type of computation required, and the number and the location of the operands required for performing the computation. Rename unit 210 may rename registers, whenever possible, to resolve any dependencies that would have prevented concurrent execution of the instructions. Pick unit 212 may pick an instruction for execution and provide the instruction to issue unit 214 so that the instruction can be issued to an execution unit. Pick unit 212 may support load/store speculation by retaining the load/store instructions in case they need to be replayed because of an incorrect speculation. Pick unit 212 may also be configured to introduce holes in the pipeline to manage downstream pipeline hazards. Issue unit 214 may be configured to determine which execution unit to use for executing an instruction. Specifically, if the instruction requires a specialized computation (e.g., a floating point computation), issue unit 214 may issue the instruction to the specialized unit. In some embodiments of the present invention, logic can be added to one or more execution units to support instructions for performing operations that are specific to DES computations.

The processor core illustrated in FIG. 2 is for illustration purposes only, and is not intended to limit embodiments of the present invention to the forms disclosed. Specifically, an embodiment of the present invention may be incorporated in a processor core that does not support out-of-order execution.

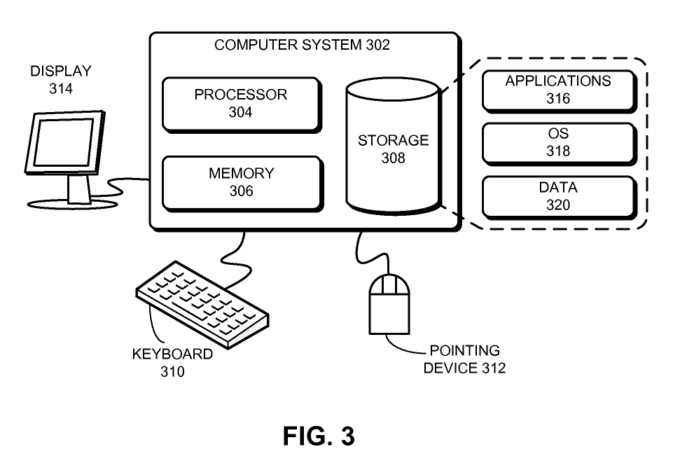

FIG. 3 illustrates a computer system in accordance with an embodiment of the present invention.

A computer system, or a computer, can generally be any device that can perform computations. Computer system 302 comprises processor 304, memory 306, and storage 308. Computer system 302 can be coupled with display 314, keyboard 310, and pointing device 312. Processor 304 may support instructions that are specifically designed for performing DES computations.

A storage device can generally be any device, now known, or later developed, that can store data. Specifically, a storage device can be a magnetic, an optical, or a magneto-optical storage device, or based on flash memory and/or battery-backed up memory. Storage 308 can store applications 316, operating system 318, and data 320.

Applications 316 and/or operating system 318 can perform DES encryption or decryption using instructions that are specifically designed for performing DES computations. Data 320 can include secrets, seeds, keys, certificates, nonces, and/or any other information that may be required for performing cryptographic operations.

### Data Encryption Standard (DES)

DES is based on a symmetric-key encryption process that uses a 56-bit key. DES takes a 64-bit block and transforms the block through a series of operations into another 64-bit block. DES uses a key to customize the transformation, so that decryption can only be performed by those who know the key that was used to perform encryption. The key consists of 64 bits, but only 56 of the 64 bits are actually used by the encryption or decryption process. The remaining eight bits may be used for checking parity, and may thereafter be discarded.

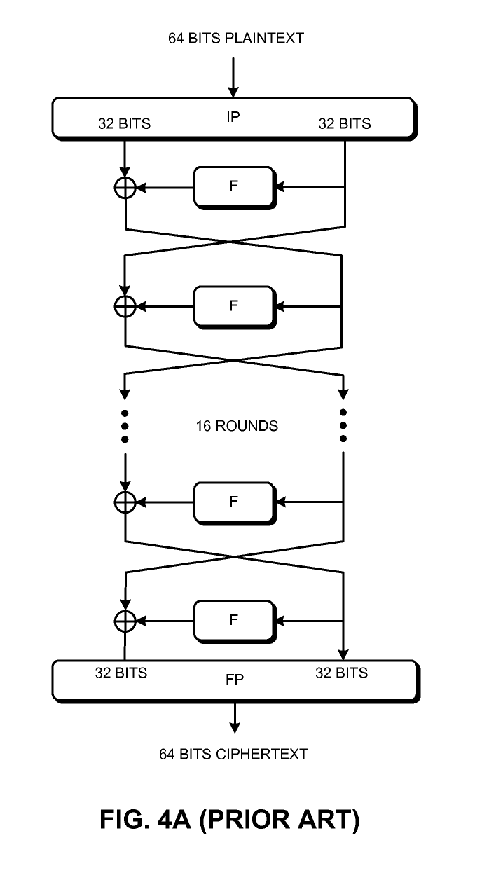

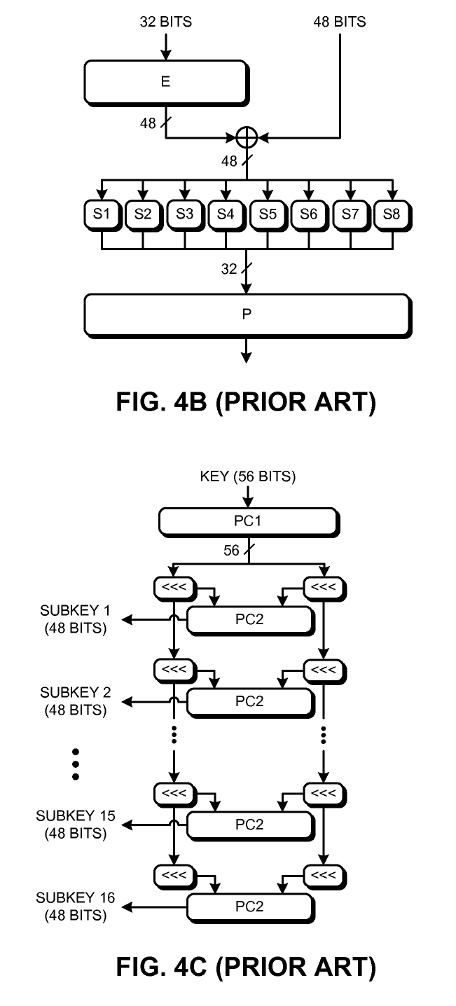

FIG. 4A presents a flowchart that illustrates the overall structure of the DES encryption/decryption process. As shown in FIG. 4, there are 16 identical stages of processing, termed rounds. The initial permutation (IP) is applied before the 16 rounds, and the final permutation (FP) is applied after the 16 rounds. Note that IP and FP are inverses of each other.

The 16 rounds process the two 32-bit halves alternately according to a crisscrossing scheme known as the Feistel scheme. Specifically, the “F” operation scrambles half a block together with some of the key. The output from the “F” operation is then combined with the other half of the block, and the halves are swapped before the next round. Note that the “⊕” symbol denotes the exlusive-OR operation. The encryption and decryption processes in DES are very similar. Specifically, the only difference between encryption and decryption is that, during decryption, the subkeys are applied in the reverse order of encryption.

FIG. 4B presents a flowchart that illustrates how the “F” operation can be performed on half a block. The 32-bit half-block can be expanded to 48 bits using the expansion permutation E. Next, the 48-bit result of the expansion permutation E can be combined with a subkey using an exclusive-OR (XOR) operation.

The result of the XOR operation can then be processed using the so-called “S-BOXES,” or substitution boxes. Each “S-BOX” converts a 6-bit value to a 4-bit value. In other words, the 48-bit output from the XOR operation is partitioned into eight 6-bit values which are fed into each of the eight S-boxes. The 4-bit outputs from the eight S-boxes are combined to form a 32-bit output which is then permuted by permutation operation P.

FIG. 4C presents a flowchart that illustrates how the subkeys for each of the 16 rounds can be derived from the main key according to the key schedule. The 56-bit key is processed by an operation called permutation choice 1 (PC-1) to produce a 56-bit output, which is split into two 28-bit halves. Each of the 28-bit halves are rotated by one or two bits in each round, and the rotated halves are input into an operation called permutation choice 2 (PC-2), which outputs a 48-bit subkey. This subkey is then used in the “F” operation as shown in FIG. 4B.

Further details of DES can be found in many sources, such as in “Applied Cryptography,” by Bruce Schneier, Second Edition, John Wiley & Sons, 1996. Details of DES can also be found in co-pending U.S. application Ser. No. 12/414,755 entitled “Apparatus and Method for Implementing Instruction Support for the Data Encryption Standard (DES) Algorithm,” by inventors Christopher H. Olson, Gregory F. Grohoski, and Lawrence A. Spracklen, which was filed on 31 Mar. 2009, and which is hereby incorporated by reference to provide details of DES.

### New Instructions for Supporting DES Computations

An important characteristic of an instruction set architecture is the number of operands that an instruction uses. An instruction that performs two rounds of DES in the same instruction requires three operands. It is not desirable to use too many bits in the instruction for identifying the operands because that can drastically reduce the number of bits that can be used for the opcode. For example, if we assume that each operand uses 5 bits in the opcode for addressing, then the number of 3-operand instructions that can be supported is 32 times less than the number of 2-operand instructions that can be supported. In other words, it can be advantageous to perform DES computation using instructions that require at most two operands.

To the extent possible, special-purpose registers are avoided in processor designs. Usually a few special-purpose registers are required, such as the program counter that holds where the next instruction to be executed is located, and a register that contains the value of various flags (e.g., the rounding mode flag). However, other than these few instances, special-purpose registers are generally avoided in processer designs. The problem with special-purpose registers is that they require special data paths and special methods to get information into and out of them. This requires extra design time and verification effort. Thus, special-purpose registers are only used where absolutely necessary.

An advantage of using general-purpose registers instead of special-purpose registers is that most instructions obtain their operands from, and put their results into, general-purpose registers. Hence, once the general-purpose registers are implemented correctly, and the methods of putting data in them and getting data from them are known to be correct, no additional effort is needed for the register usage by all the instructions that use them. According to one definition, a general-purpose register is a register that is used by the processor to perform the standard arithmetic and logic operations, such as, addition, subtraction, logical OR, logical AND, etc.

Each instruction that uses general-purpose registers may put a result in at most one general-purpose register. Note that each DES round modifies the text (64 bits) and key (56 bits). Hence, general-purpose registers that are at most 64-bits wide (which is a very typical size) cannot be used to store the output of a round operation, since each round operation produces a 120 (=64+56) bit result. Hence, conventional implementations of DES-specific instructions use special-purpose registers.

For example, in conventional DES implementations, all the text and key data needed is held in special-purpose registers. Specifically, the 64-bit data block is held in two special-purpose registers, and the 56-bit key block is held in the two more special-purpose registers. Each time the DES round instruction is executed, all four of these special-purpose registers are read at the start of the instruction and all four are written at the end of the instruction. No general-purpose registers are used.

It would be advantageous to have a system and method for encrypting/decrypting data in accordance with the DES encryption/decryption process that overcame these deficiencies. Some embodiments of the present invention provide a system and method for using a general-purpose processor to implement permutation and/or round opcodes for encrypting and/or decrypting data in accordance with the DES process. Specifically, some embodiments of the present invention overcome this problem by breaking up the DES encryption and decryption process into a series of operations that do not require writing two results.

Some of the drawbacks of conventional techniques include added expense, size, and/or processing time. For example, a conventional hardware implementation may add expense and size by requiring a dedicated DES processor. Furthermore, a conventional software implementation may take longer to process data because the software routines are limited to the standard instruction set available to the general-purpose processor (e.g., add, shift, subtract, etc.), and because a large number of standard instructions are required to implement the DES encryption and decryption process.

Table 1 shown below illustrates how the DES encryption process may be divided into 34 separate and discrete operations in accordance with an embodiment of the present invention. Note that the DES encryption process has been divided in Table 1 so that only one output needs to be written in each operation.

TABLE 1
DES encryption process divided into 34 operations.

| No. | Operation |
|---|---|
| 1 | Perform initial permutation of T0, obtaining T1. |
| 2 | Select 56 bits of K0, and perform a PC1 permutation followed by |
| | a circular rotate of each 28-bit halves by 1, obtaining K1. |
| | Note that K1 is treated as two 28-bit halves. |
| 3 | Perform a round computation with T1 and K1, obtaining T2. |
| 4 | Circular rotate each half of K1 by 1, obtaining K2. |
| 5 | Perform a round computation with T2 and K2, obtaining T3. |
| 6 | Circular rotate each half of K2 by 1, obtaining K3. |
| 7 | Perform a round computation with T3 and K3, obtaining T4. |
| 8 | Circular rotate each half of K3 by 2, obtaining K4. |
| 9 | Perform a round computation with T4 and K4, obtaining T5. |
| 10 | Circular rotate each half of K4 by 2, obtaining K5. |
| 11 | Perform a round computation with T5 and K5, obtaining T6. |
| 12 | Circular rotate each half of K5 by 2, obtaining K6. |
| 13 | Perform a round computation with T6 and K6, obtaining T7. |
| 14 | Circular rotate each half of K6 by 2, obtaining K7. |
| 15 | Perform a round computation with T7 and K7, obtaining T8. |
| 16 | Circular rotate each half of K7 by 2, obtaining K8. |
| 17 | Perform a round computation with T8 and K8, obtaining T9. |
| 18 | Circular rotate each half of K8 by 2, obtaining K9. |
| 19 | Perform a round computation with T9 and K9, obtaining T10. |
| 20 | Circular rotate each half of K9 by 1, obtaining K10. |
| 21 | Perform a round computation with T10 and K10, obtaining T11. |
| 22 | Circular rotate each half of K10 by 2, obtaining K11. |
| 23 | Perform a round computation with T11 and K11, obtaining T12. |
| 24 | Circular rotate each half of K11 by 2, obtaining K12. |
| 25 | Perform a round computation with T12 and K12, obtaining T13. |
| 26 | Circular rotate each half of K12 by 2, obtaining K13. |
| 27 | Perform a round computation with T13 and K13, obtaining T14. |
| 28 | Circular rotate each half of K13 by 2, obtaining K14. |
| 29 | Perform a round computation with T14 and K14, obtaining T15. |
| 30 | Circular rotate each half of K14 by 2, obtaining K15. |
| 31 | Perform a round computation with T15 and K15, obtaining T16. |
| 32 | Circular rotate each half of K15 by 2, obtaining K16. |
| 33 | Perform a round computation with T16 and K16, obtaining T17. |
| 34 | Perform the final permutation of T17, obtaining the result. |

In the above table, T0 is the text input, K0 is the key input, and T17 (the value after the final permutation) is the result. In triple-DES, the DES encryption/decryption process is performed three times. Specifically, triple-DES encryption involves performing a DES encryption, followed by a DES decryption, followed by a DES encryption. Triple-DES decryption involves performing a DES decryption, followed by a DES encryption, followed by a DES decryption. In one embodiment, each DES encryption/decryption operation in triple-DES uses a different key. In another embodiment, the two DES encryption operations in triple-DES use the same key, but the DES decryption operation in triple-DES uses a different key.

The operations shown in Table 1 may be categorized into an initial permutation, a key permutation, round computations, rotation by one and two places (which are permutations), and a final permutation. Thus, the DES process can be broken down into two operations: permutations and round computations.

While the round computations are the same regardless of whether the data is being encoded or decoded, the same is not necessarily true for the permutations. For example, one key permutation is used when data is being encrypted and a different key permutation is used when data is being decrypted. Furthermore, the rotation by one or two computations involve rotations to the left when data is being encrypted, and rotations to the right when data is being decrypted. Therefore, the permutations can further be broken down into an initial permutation, a key permutation (encryption), a key permutation (decryption), a rotation by one to the left, a rotation by two to the left, a rotation by one to the right, a rotation by two to the right, and a final permutation.

This analysis of DES leads us to an important insight: the DES encryption and decryption process can be expressed as a series of operations which require two types of computations: a round computation that operates on two values (e.g., in operation no. 3 in Table 1, the operands are T1 and K1), and permutation (or rotation) computations that operate on a single value (e.g., in operation no. 1 in Table 1, the operand is T0).

Some embodiments of the present invention modify a general-purpose processor, or more particularly, an execution unit to implement any of these operations in a manner that is similar to how the general-purpose processor implements subtract and shift operations. Specifically, the round operation, like the subtract operation, includes an opcode (i.e., a round opcode), a destination identifier, and two operand identifiers. The permutation (or rotation) operation, like the shift operation, includes an opcode (i.e., a permutation opcode), a destination identifier, an operand identifier, and a permutation identifier (i.e., a value to indicate which permutation is to be performed).

Exemplary embodiments of a round instruction and a permutation (or rotation) instruction are described in further detail in the following sections.

Permutation and/or Rotation Instruction

The first operation of the DES process as shown in Table 1 is an initial permutation. The initial permutation operates on the text data (i.e., T0[63:0]), to produce permuted text data (i.e., T1[63:0]). A general-purpose processor can implement the initial permutation operation by fetching a permutation instruction, including a permutation opcode, a destination identifier rd, an operand identifier rs1, and a permutation identifier rs2. After decoding the permutation opcode, the control unit can provide a permutation request and the permutation identifier rs2 (i.e., the second operand) to the modified EU, e.g., the modified ALU. The permutation identifier rs2 further delineates the type of permutation operation that is to be performed. The control unit also provides the operand identifier rs1 to the general-purpose registers. The general-purpose registers then provide the content of the register rs1 (i.e., r[rs1]), corresponding to the text data, to the modified EU. The modified EU then performs the initial permutation operation on the operand to produce a result (i.e., the permuted text data, T1[63:0]). The result is then provided to the general-purpose registers along with the destination identifier (i.e., rd). This allows the result to be stored into register rd of the general-purpose registers.

The second operation of the DES encryption/decryption process is a key permutation which can be accomplished in a similar manner as the first operation. The key data differs from the text data in that only 56 bits of the key data are used. Thus, the 64-bit key data (i.e., K1[63:0]) includes eight unused bits. In the exemplary DES encryption/decryption process described herein, bits K1[27:0] represent the least significant half of the key data that are used, and bits K1[59:32] represent the most significant half of the key data bits that are used. It should be appreciated, however, that these bits could be located elsewhere within K1[63:0] with proper adjustment of the indices.

The fourth and eighth operations of the DES encryption/decryption process are a rotation-by-one permutation and a rotation-by-two permutation, respectively. The rotation operations can be accomplished in a manner that is similar to the other permutation operations. In performing the rotation of the keys (either by one or by two), each 56-bit set of key data is treated as two 28-bit sets, where each set is rotated independently of the other.

The last operation of the DES encryption/decryption process is a final permutation which can be accomplished in a manner that is similar to the other permutations. Any other permutation and rotation operations shown in Table 1 can be similarly performed. Note that in all of these permutations (including the rotations), no special-purpose registers were used; all data was obtained from, and results were put in, general-purpose registers.

Round Instruction

The round operation, e.g., the third operation in Table 1, operates on text data and key data to produce a new text data. The general-purpose processor can implement the round operation by fetching a round instruction, including a round opcode, a destination identifier rd, and two operand identifiers rs1, rs2. After decoding the round opcode, the control unit can provide a round request to the modified EU (i.e., instructing the modified EU to perform a round operation) and two operand identifiers rs land rs2 to the general-purpose registers. The general-purpose registers can then provide the contents of registers rs1 and rs2 (i.e., r[rs1] and r[rs2]), corresponding to the text data and the key data, to the modified EU. The modified EU can then perform a round operation on the operands.

The round operation can be further broken down into the following sub-operations: an expand operation and permutation, an XOR operation, a look-up table operation, a permutation operation, and another XOR operation and concatenation.

The modified EU can first perform the expansion operation on the right half of the text data (i.e., T1[31:0]). This can be accomplished by duplicating half of the bits of the right half of the text data and arranging the resulting 48 bits in the correct order as specified by the DES encryption/decryption process. Note that this operation can be implemented by routing wires to the correct places, and hence, no logic gates are required.

The modified EU can then perform an XOR operation on the expanded bits of the text data and selected bits from the key data to produce a 48-bit E value. Next, the modified EU can perform the look-up table operation on the 48-bit E value to produce a 32-bit S value. The look-up table values provide a different kind of permutation from all the other DES permutations. All the other DES permutations are accomplished by rearranging the order of the wires carrying the data (the expansion permutation duplicates some of the wires before reordering). However, the look-up table permutations (often called S-BOX permutations, or substitutions) take as input the value of the input wires to determine a different value for the output wires. For example, if the input value to the first S-BOX permutation were zero (all input bits off), then the output is the value 14, which has three bits on and thus cannot be obtained by simply rearranging the input wires. The S value is then permuted by the modified EU using the P permutation to produce the P value. As with the first operation, this is just a matter of routing wires to the correct places, and hence, the permutation can be accomplished without using any logic gates.

In the last operation, the modified EU can perform another XOR operation, this time on the 32 most significant bits of the text data (i.e., T1[63:32]) and the permuted 32-bit P value to produce a 32-bit R value. This R value is then used, along with the right half of the text data, to produce a result text data (i.e., T2[63:32]=T1[31:0] and T2[31:0]=R[31:0]). The result text d (i.e, T2[63:0]) is then provided to the general-purpose registers along with the destination identifier (i.e., rd). This allows the result to be stored into register rd of the general-purpose registers.

As stated above, the DES encryption and decryption process specifies both an expansion of the least significant 32 bits of the text data before the first XOR operation, and also a permutation of the table look-up result before the second XOR operation. Whereas in software these operations require a large number of instructions, some embodiments of the present invention can accomplish these operations by appropriately routing the wires as they are coupled to the inputs of the XOR gates. Consequently, no logic gates need to be used to perform these operations. Note that no special-purpose registers were used in the round operation; all data was obtained from, and results were put in, general-purpose registers.

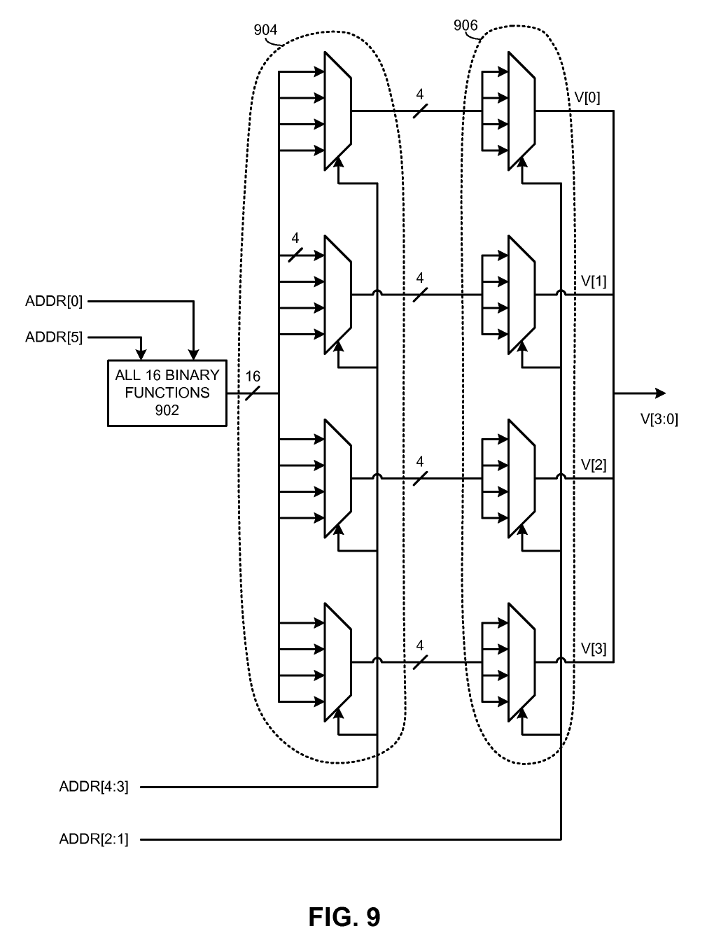

To maximize the efficiency of the processing system, the look-up table should have a relatively quick response time. If a fast ROM is not available, a quick response time can be achieved by using combinatorial logic (see FIG. 9 and the associated text) to produce the required S value.

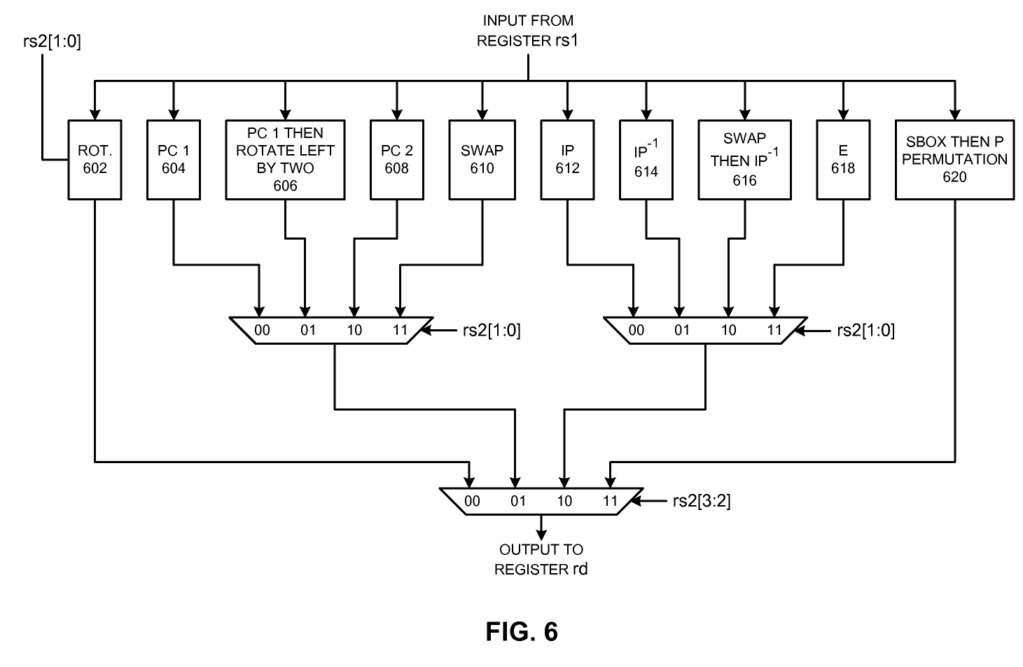

The result of the last round computation (i.e., operation no. 33) should be assembled in reverse order (i.e., T17[63:32]=P[31:0] and T17[31:0]=T16[31:0]) before the final permutation operation is performed (operation no. 34). Either an alternate round opcode could be implemented to produce a reverse order result, or the permutation opcode could be modified to implement a reverse order permutation, either as a stand-alone swap (e.g., circuit block 610 in FIG. 6) or together with the final permutation (e.g., circuit block 616 in FIG. 6).

While the operations illustrated in Table 1 reflect a single iteration of the DES encryption/decryption process, it should be appreciated that additional iterations of DES can also be performed (e.g., performing triple-DES). Moreover, if multiple iterations of the DES encryption/decryption process are performed (e.g., as with triple-DES), a single first/final permutation operation may be performed on the text data in lieu of a final permutation operation of one iteration followed by an initial permutation operation of the next iteration.

It should also be appreciated that the round and permutation opcodes/operations described above not only allow the modified EU of the general-purpose processor to implement the DES encryption/decryption process, but the DES encryption/decryption process is broken down in such a manner that the result of each operation is, at most, 64 bits in length. This is significant because most general-purpose registers are 64-bit registers. Thus, an embodiment of the present invention not only enables a general-purpose processor to implement the DES encryption/decryption process by using an EU modified to implement round and/or permutation opcodes, but the embodiment does so using the general-purpose control structure and the general-purpose registers. No special-purpose registers are used and no special-purpose control structure is needed.

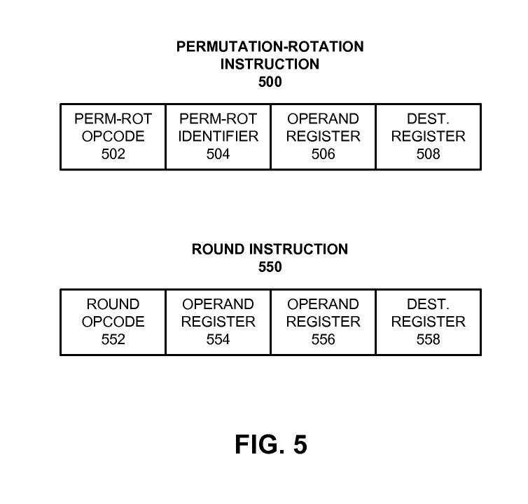

FIG. 5 illustrates an exemplary format for a permutation-rotation instruction and a round instruction in accordance with an embodiment of the present invention.

Permutation-rotation instruction 500 can include permutation-rotation opcode 502, permutation-rotation identifier 504, operand register field 506, and destination register field 508. Permutation-rotation opcode 502 can be used by a decode unit to determine that either a permutation operation or a rotation operation is desired to be performed. Permutation-rotation identifier 504 can be used by a decode unit to determine the type of permutation or the type of rotation that is desired to be performed. Operand register field 506 can be used to determine the general-purpose register the operand is stored in. Destination register field 508 can be used to determine the general-purpose register the result is to be stored in.

Round instruction 550 can include round opcode 552, operand register field 554, operand register field 556, and destination register field 558. Round opcode 552 can be used by a decode unit to determine that a round operation is desired to be performed. Operand register field 554 can be used to determine the general-purpose register that contains the first operand for the round operation. Operand register field 556 can be used to determine the general-purpose register that contains the second operand for the round operation. Destination register field 558 can be used to determine the general-purpose register to store the result in.

FIG. 6 illustrates a block diagram for a circuit, which can be used to support a permutation-rotation instruction that uses general-purpose registers in accordance with an embodiment of the present invention. The circuit shown in FIG. 6 is for illustration purposes only and is not intended to limit the present invention. It will be apparent to one skilled in the art that a number of variations and modifications are possible.

The circuit shown in FIG. 6 includes a plurality of circuit blocks which perform various operations for DES encryption and decryption. Specifically, the circuit shown in FIG. 6 includes circuit block 602 which performs rotations, circuit block 604 which performs PC 1 permutation, circuit block 606 which performs a PC 1 permutation and a rotate left by two rotation, circuit block 608 which performs a PC 2 permutation, circuit block 610 which performs a swap operation, circuit block 612 which performs an initial permutation, circuit block 614 which performs the inverse of the initial permutation, circuit block 616 which performs a swap operation and an inverse of the initial permutation, circuit block 618 which performs the expansion E operation, and circuit block 620 which performs the S-BOX look-up followed by the P permutation.

The outputs of these circuit blocks are propagated through a series of multiplexers as shown in FIG. 6. These multiplexers can be controlled using bits of the instruction. Specifically, rs1 can be identified by the operand register field 506, rs2 can be the permutation-rotation identifier 504, and the output of the circuit shown in FIG. 6 can be stored in register rd which can be specified by the destination register field 508.

During operation, each circuit block shown in FIG. 6 can perform its computations on the input from register rs1. Next, the bits of register rs2 can be used to select which circuit block's output is stored in destination register rd. Note that the notation rs1[1:0] is used to refer to the two least significant bits of the rs1 field. In this manner, the circuit shown in FIG. 6 can be used to perform a variety of permutations and rotation operations in a highly efficient fashion.

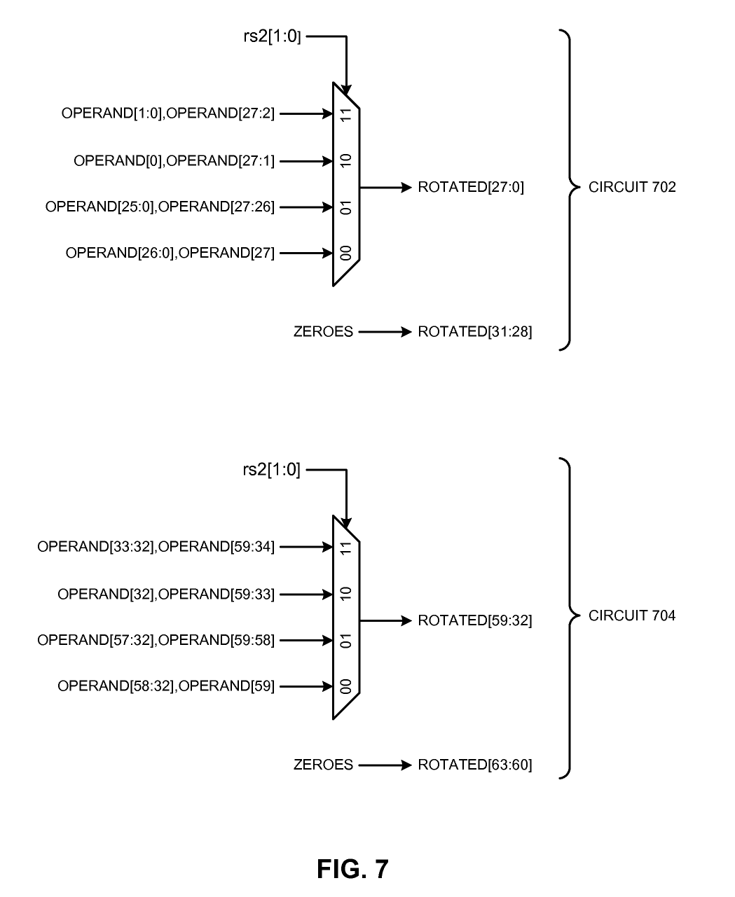

FIG. 7 illustrates a block diagram for a circuit which can be used to perform rotation operations in accordance with an embodiment of the present invention. The circuit shown in FIG. 7 is for illustration purposes only and is not intended to limit the present invention. It will be apparent to one skilled in the art that a number of variations and modifications are possible. Note that the circuit shown in FIG. 7 is an exemplary implementation of rotation circuit block 602 illustrated in FIG. 6.

Recall that the rotation operation takes a single operand as an input. The output of the rotation operation is a rotation of the two 28-bit portions stored in the operand. These 28-bit portions correspond to the sub-keys that are used in each of the 16 round computations shown in FIG. 4C. In FIG. 7, the operand to the rotation operation is assumed to be 64 bits wide. The two 32-bit halves of the operand can store the two 28-bit halves of the 56-bit key.

Circuit 702 performs rotations on the 32 least significant bits, i.e., bits 0 through 31, of the operand. In circuit 702, the bits of the operand are rotated by routing the wires appropriately, and the four different types of rotations are fed into a multiplexer which is controlled by rs2[1:0]. Note that rs2[1:0] is shown as an input to rotation circuit block 602 in FIG. 6. The value of the two bits rs2[1:0] determine which of the four rotations is selected. The 4 most significant bits in this half of the 64-bit operand, i.e., OPERAND[31:28], are set to zero.

Circuit 704 performs rotations on the 32 most significant bits, i.e., bits 32 through 63, of the operand. In circuit 704, the bits of the operand are rotated by routing the wires appropriately, and the four different types of rotations are fed into a multiplexer which is controlled by rs2[1:0]. The 4 most significant bits in this half of the 64-bit operand, i.e., OPERAND[63:60], are set to zero.

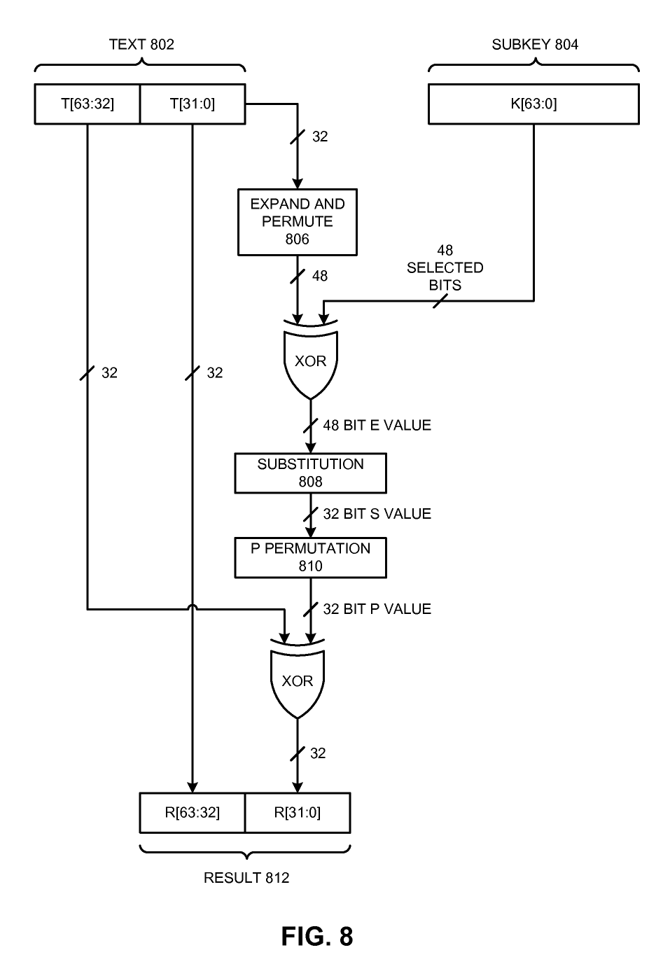

FIG. 8 illustrates a block diagram for a circuit which can be used to perform round operations in accordance with an embodiment of the present invention. The circuit shown in FIG. 8 is for illustration purposes only and is not intended to limit the present invention. It will be apparent to one skilled in the art that a number of variations and modifications are possible.

Recall that the round operation has two inputs, namely, text 802 and subkey 804, and one output, namely result 812. The two inputs can be stored in two 64-bit general-purpose registers which can be identified by two operand register fields in the round instruction, e.g., operand register fields 554 and 556 in round instruction 550. The output can be stored in a 64-bit general-purpose register which can be identified by a destination register field in the round instruction, e.g., destination register field 558 in round instruction 550.

In FIG. 8, the two 64-bit operands are shown as T[63:0] and K[63:0]. These inputs can be processed using the various circuit blocks shown in FIG. 8. Specifically, T[31:0] can be fed into circuit block 806 which performs expansion and permutation to product a 48-bit result. This result is then XORed with 48 selected bits of subkey 804. The output of the XOR operation is then input into the substitution circuit block 808, and the resulting 32-bit output is fed into circuit block 810 which performs the P permutation. The output of the P permutation operation is then XORed with the 32 most significant bits of the text, i.e., T[63:32], and the result is stored in the 32 least significant bits of the destination register, i.e., R[31:0]. The 32 least significant bits of the text, i.e., T[31:0] is stored as-is in the 32 most significant bits of the destination register, i.e., R[63:32].

An alternate version of the round instruction would swap the two halves of the result. That is, the output of the alternate version would be R[63:32]=P[31:0], where “P” is the output of circuit block 810, and R[31:0]=T[31:0]. This alternate version could be useful for the last round (operation no. 33 in Table 1). If the alternate version of the round operation is not available, the swap of the two halves of the result could be included with the permutation in operation no. 34 in Table 1.

FIG. 9 illustrates a circuit which uses logic gates (instead of a read-only memory) to implement the S-BOX look-up tables in accordance with an embodiment of the present invention. The circuit shown in FIG. 9 is for illustration purposes only and is not intended to limit the present invention. It will be apparent to one skilled in the art that a number of variations and modifications are possible.

The circuit shown in FIG. 9 takes a 6-bit input, ADDR[6:0], and generates a 4-bit output V[3:0] according to the S-BOX look-up. Circuit block 902 generates all 16 binary functions based on 2-bit input ADDR[0] and ADDR[5]. (Note that the number of functions that map an n-bit value to a 1-bit value is 2 raised to 2 raised to n. Hence, the total number of functions that map a 2-bit value to a 1-bit value is 2 raised to 2 raised to 2, which is equal to 16.)

These sixteen binary function values are then fed into a first set of multiplexers 904, and then into a second set of multiplexers 906. Each input of the first set of multiplexers 904 is four bits wide. Each input of the second set of multiplexers 906 is one bit wide. Each multiplexer in the first set of multiplexers 904 uses two bits of the 6-bit input, e.g., ADDR[4:3], to select a four-bit input. This four-bit input is then fed into a multiplexer in the second set of multiplexers 906. Each multiplexer in the second set of multiplexers 906 uses two other bits of the 6-bit input, e.g., ADDR[2:1], to select one of the input bits.

In this manner, a six-bit input ADDR[5:0] can be used to generate a four-bit output V[3:0]. By choosing the appropriate binary functions in circuit box 902, the circuit shown in FIG. 9 can implement each of the eight S-BOX look-up tables. Further details of how the circuit shown in FIG. 9 can be used to achieve the S-BOX look-up tables can be found in U.S. Pat. No. 6,768,684, entitled “System and Method for Small Read Only Data,” by Leonard D. Rarick, issued on 27 Jul. 2004, which is hereby incorporated by reference to describe how combinational logic can be used to implement a look-up table.

In an embodiment of the present invention, the entire DES encryption/decryption process is implemented in hardware without using a round opcode. In this embodiment, the round computations illustrated in FIG. 8 are implemented using two XOR operations (note that the XOR operation is already in the standard instruction set of most general-purpose processors) and additional permutations, as illustrated in FIG. 6.

Specifically, in this embodiment, the round operation can be accomplished by implementing an expansion permutation operation (circuit block 618) on selected bits from the input text data, and a select-key permutation operation on selected bits from the key data (circuit blocks 605, 606, and 608). The XOR operation is then performed on these two results, which produces the 48-bit E value shown in FIG. 8.

The value substitution permutation (or the look-up table operation) is used to determine the 32-bit S value as described above (circuit block 620). This may be combined with the bit permutation to produce the 32-bit P value (circuit block 620). Another XOR operation is then performed on the 32-bit P value and the 32 most significant bits of text data (i.e., T1[63:32]) to produce the 32-bit R value. This R value is then used, along with right half of the text data to produce a result data (i.e., T2[63:32]=T1[31:0] and T2[31:0]=R[31:0]) using shifts and an OR operation. It should be appreciated, however, that this method of implementing the round operations does not affect the fact that the final set of text data needs to be reversed before the final permutation operation is performed, as discussed above.

In another embodiment, one round instruction may implement two round operations and the circular rotation of each half of the key. In this case, a circular rotation by 3 or 4 is needed to be ready for the next round operation and could be provided by an additional permutation opcode.

In another embodiment, if enough registers are available, all the circular rotations may be performed and the results placed in general-purpose registers before any encryption or decryption is started. Then, except for the initial and final permutations, only the round operations need be executed for the encryptions and decryptions. This has an additional advantage in that the circular rotations are computed only once, whereas the round operations need to be executed many times, the number of times depending on the length of the message being encrypted or decrypted.

In yet another embodiment, some general-purpose processors can obtain data from three general-purpose registers as data inputs from some instructions, such as the multiply-add instruction that computes R=(A*B)+C. If the round operation can be implemented quickly enough and the rotations of the key have been stored in the general-purpose registers, then two rounds may be executed with one instruction, and the two keys needed can be supplied from the general-purpose registers without having to compute the second circularly rotated key from the first key input. A variation on this embodiment, in which two rounds are computed by the round opcode, is that only two inputs are supplied, the text data and the first needed key data. The second needed key data may be obtained from the first needed key data by the implementation of the appropriate rotation within the round opcode execution. In this case, only half of the keys needed for an encryption or decryption need be placed in the general-purpose registers. Note that it may be advantageous in this embodiment to have rotation of 1, 2, 3, and 4 provided by the permutation opcode instead of 1, 2, −1, and −2.

If at least two instructions could be executed at the same time, then the process shown in Table 1 could be done in as little as 18 clock cycles, as follows. In the first clock cycle, operation nos. 1 and 2 are performed. In the second clock cycle, operation nos. 3 and 4 are performed, and so forth. Operation nos. 31 and 32 would be performed in the 16th clock cycle. In the 17th clock cycle, operation no. 33 will be performed, and in the 18th clock cycle, operation no. 34 will be performed. Note that since the output of operation no. 33 is used in operation no. 34, they cannot be performed concurrently in the 17th clock cycle. For triple-DES, operation no. 34 of one DES cycle can be combined with operation no. 1 of the next. Thus the total number of clock cycles required to perform triple-DES could be only 52.

Specifically, the two round iterations could be organized as three inputs: the key for the first round, the key for the second round, and the input text. The output would be the text after the two rounds are finished.

The longest path in the round operation is an XOR, then a table look-up, and finally another XOR as shown in FIG. 8. For this to be executed as a one clock instruction, the table look-up must be fast. If a read-only memory (ROM) based table look-up is not fast enough, the circuit shown in FIG. 9 can be used. In this case, the time to do a table look-up is the time of one XOR followed by a 4-input multiplexer, and finally another 4 input multiplexer, as shown in FIG. 9.

If we use the circuit shown in FIG. 9, the time required to perform the round operation will most likely be comparable to the time required to perform a 64-bit fixed-point addition. Specifically, the round operation requires three XOR operations and two four-input multiplexer selections. The 64-bit fixed-point addition typically requires three four-way combine operations, an XOR operation, and a two-input OR/AND logic operation. The four-way combine includes the following two logic functions: g_out=not (not(g_in[3]) and not(p_in[3] and g_in[2]) and not(p_in[3] and p_in[2] and g_in[1]) and not(p_in[3] and p_in[2] and p_in[1] and g_in[0])), and p_out=p_in[3] and p_in[2] and p_in[1] and p_in[0].

The speed of each of these operations is technology dependent. However, the following relative speeds seem to be valid over many different technologies. The two-input AND/OR execute a little quicker than the XOR operation and the four-way combine executes a little slower than the XOR operation. Thus, the round instruction would be expected to take about the same amount of time (or perhaps even less time) to execute as does the one clock 64-bit fixed point addition.

It should be appreciated that many variations and modifications are possible. For example, even though an EU modified to implement both round and permutation-rotation operations has been described above, it should be appreciated that an EU modified to implement the round operation alone or the permutation-rotation operation alone is also within the spirit and scope of the present invention.

### DES Encryption/Decryption Using the New Instructions

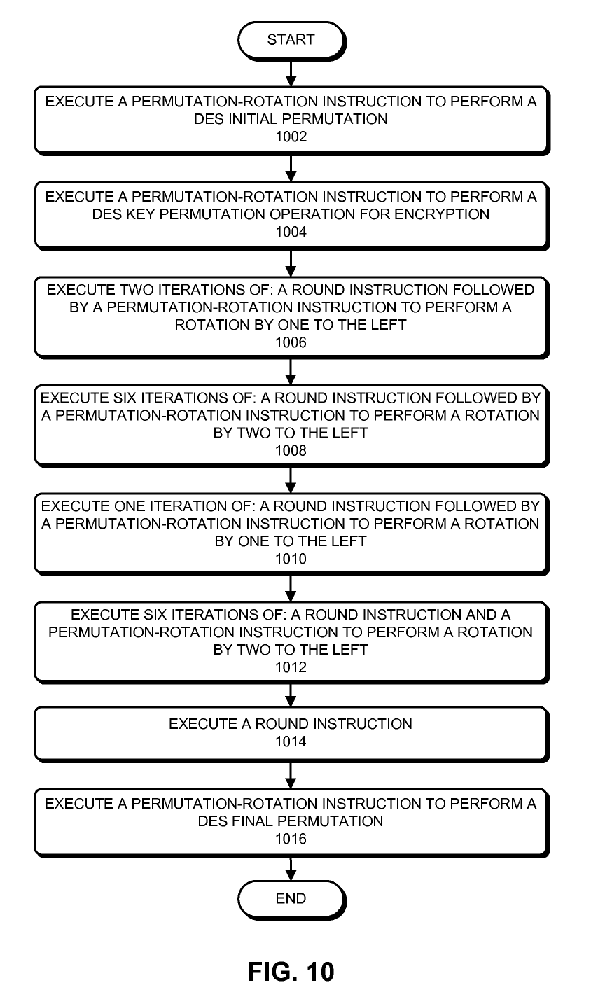

FIG. 10 presents a flowchart that illustrates a process for performing DES encryption using the permutation-rotation instructions and the round instruction in accordance with an embodiment of the present invention.

The system can receive a block which is desired to be encrypted according to DES using a processor which supports a permutation-rotation instruction and a round instruction.

The encryption process can begin by executing a permutation-rotation instruction to perform a DES initial permutation operation (operation 1002). Next, the system can execute a permutation-rotation instruction to perform a DES key permutation operation for encryption (operation 1004). The system can then execute two iterations of: a round instruction and a permutation-rotation instruction to perform a rotation by one to the left (operation 1006). Next, the system can execute six iterations of: a round instruction and a permutation-rotation instruction to perform a rotation by two to the left (operation 1008). The system can then execute one iteration of: a round instruction and a permutation-rotation instruction to perform a rotation by one to the left (operation 1010). Next, the system can execute six iterations of: a round instruction and a permutation-rotation instruction to perform a rotation by two to the left (operation 1012). The system can then execute a round instruction (operation 1014). Next, the system can execute a permutation-rotation instruction to perform a DES final permutation (operation 1016).

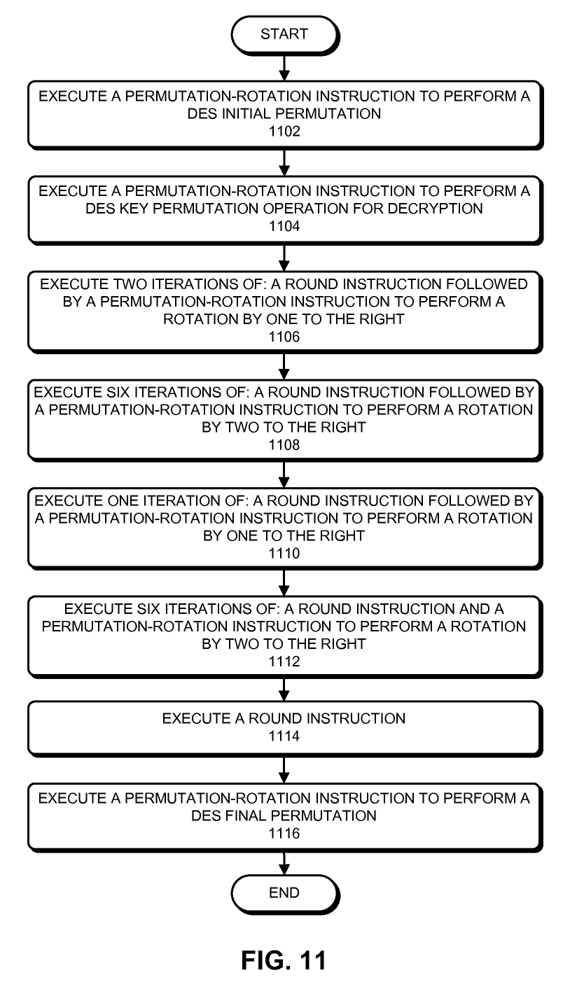

FIG. 11 presents a flowchart that illustrates a process for performing DES decryption using the permutation-rotation instructions and the round instruction in accordance with an embodiment of the present invention.

The process can begin by executing a permutation-rotation instruction to perform a DES initial permutation operation (operation 1102). Next, the system can execute a permutation-rotation instruction to perform a DES key permutation operation for decryption (operation 1104). The system can then execute two iterations of: a round instruction and a permutation-rotation instruction to perform a rotation by one to the right (operation 1106). Next, the system can execute six iterations of: a round instruction and a permutation-rotation instruction to perform a rotation by two to the right (operation 1108). The system can then execute one iteration of: a round instruction and a permutation-rotation instruction to perform a rotation by one to the right (operation 1110). Next, the system can execute six iterations of: a round instruction and a permutation-rotation instruction to perform a rotation by two to the right (operation 1112). The system can then execute a round instruction (operation 1114). Next, the system can execute a permutation-rotation instruction to perform a DES final permutation (operation 1116).

Comparison with Burke Instructions

A proposal for using general-purpose registers for private key cryptography was made in “Architectural Support for Fast Symmetric-Key Cryptography” by Jerome Burke, John McDonald, and Todd Austin, Advanced Computer Architecture Laboratory, University of Michigan, A.C.M., ASPLOS 2000, Nov. 12-15, 2000, 1-58113-317-0/00-0011, pages 178-189. This proposal (hereinafter referred to as “Burke's system”) discloses instructions that use general-purpose registers for private key (also called symmetric key) cryptography. Note that, in Burke's system, the speed improvement for the DES encryption/decryption process is about 50%. In contrast to Burke's system, embodiments of the present invention provide much greater speed improvement for DES.

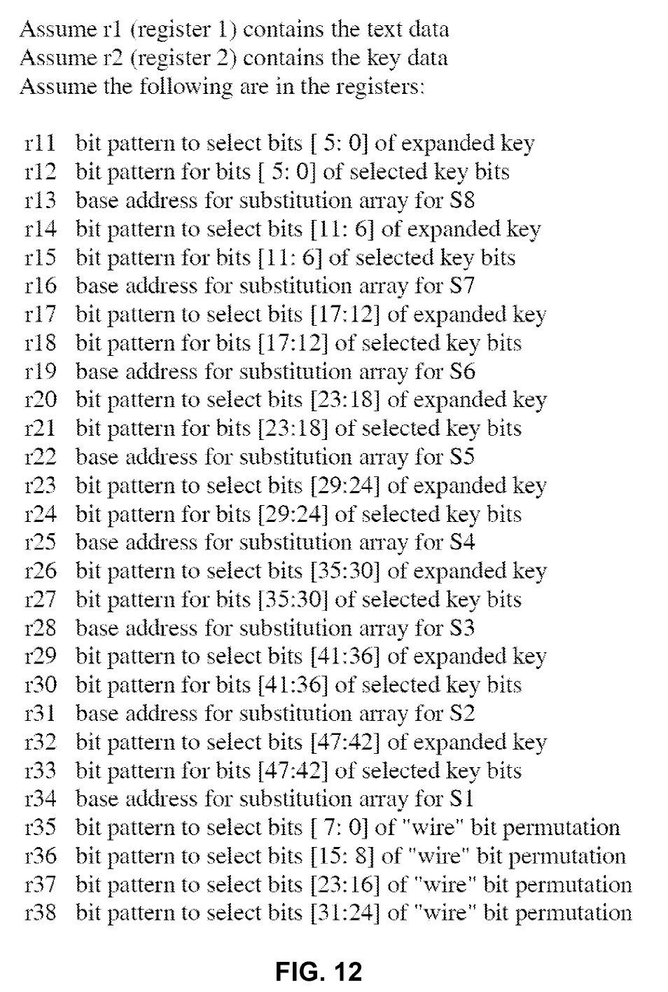

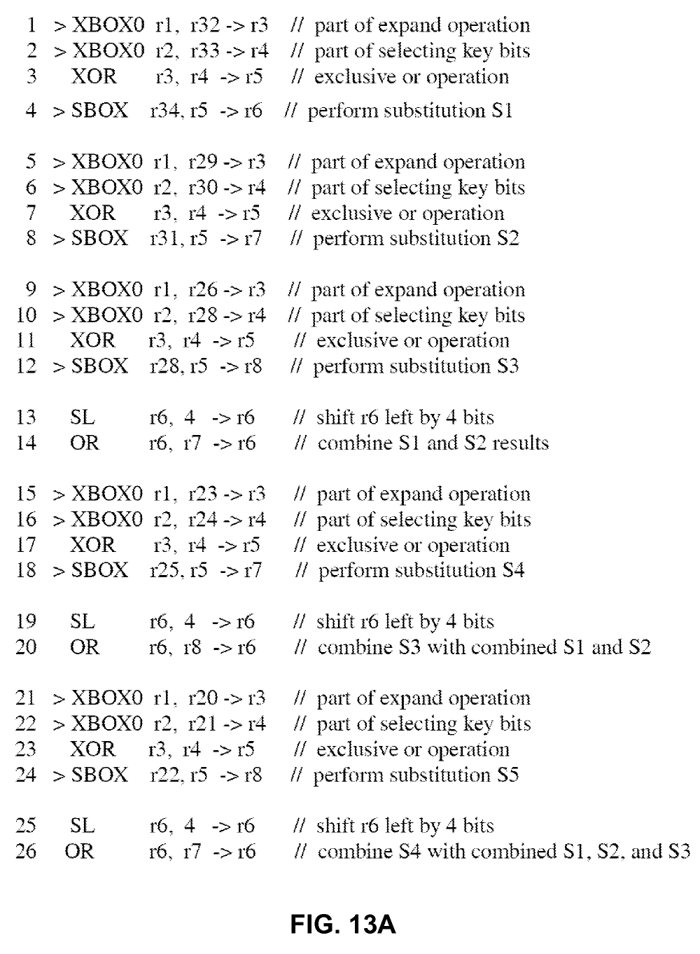

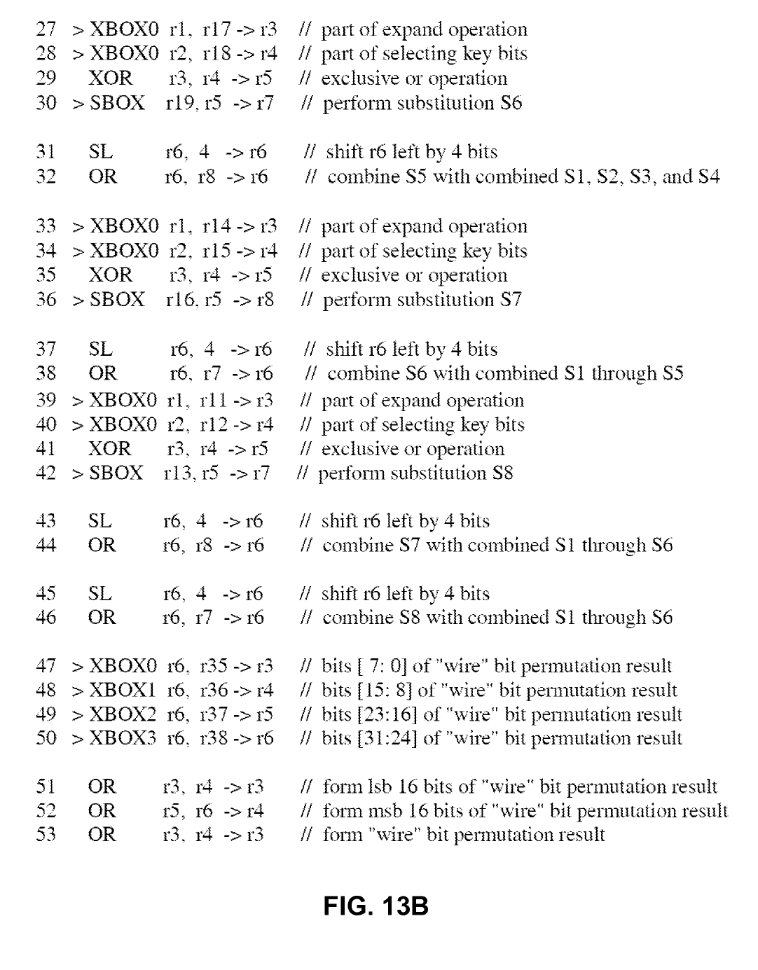

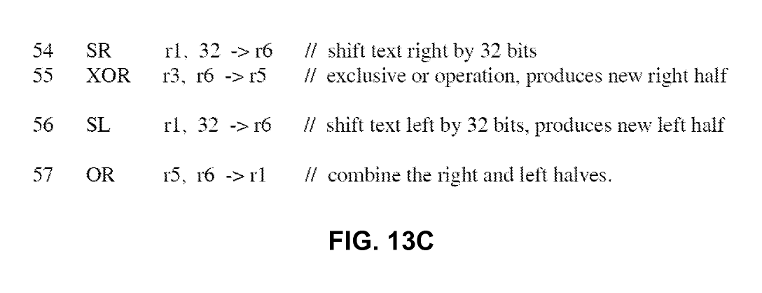

FIG. 12 and FIGS. 13A-13C illustrate how a round operation can be performed using Burke's system. Specifically, FIG. 12 illustrates the contents of the registers that are required at the beginning of the DES computation. FIGS. 13A-13C illustrate the instructions that are required to perform the round operation. The instructions marked with the symbol “>” are the special instructions in Burke's system.

Note that almost 30 registers were used just for the round operation if all information needed is kept in the registers to avoid additional instructions of swapping information in from memory. To do an entire DES iteration, one also needs to do the circular shifts and other permutations. The Burke instructions provide 64-bit and 32-bit rotate instructions, but DES needs 28-bit rotations, so the Burke instructions don't help. If everything is in the registers, Burke's system takes 5 instructions to do the DES circular rotates instead of the one instruction (the permutation-rotation instruction) that some embodiments of the present invention require. Note, however, that the permutation-rotation instruction that is supported by some embodiments of the present invention also does the input and output key and text permutations.

Overall, using Burke, to do a round iteration without using memory (except for the Burke S-BOX instructions), about 30 registers and 57+5=62 instructions are required. In contrast, some embodiments of the present invention which support the permutation-rotation instruction and the round instruction require only two registers (one for the text and one for the key), and need only two instructions to be executed. Moreover, unlike Burke's system, no memory accesses are required in these embodiments of the present invention. Hence, embodiments of the present invention are at least 30 times faster than Burke's system if 30 registers are available. However, if the computations have to be performed with fewer than 30 registers, Burke's system would be even slower because of memory accesses, and the speed-up achieved by embodiments of the present invention over Burke's system will be greater than 30×.

Note that one of the reasons embodiments of the present invention are substantially faster than Burke's system is because embodiments of the present invention support a permutation-rotation instruction and a round instruction which were designed to substantially speed-up DES computations. Furthermore, these instructions require only general-purpose registers, and in some embodiments, require at most two operands.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A processor, comprising:
a set of general-purpose registers, wherein each general-purpose register is at least 64 bits wide; and
an execution unit which supports a permutation-rotation instruction which includes an opcode which indicates that a DES permutation or rotation operation is desired to be performed, a permutation-rotation identifier which specifies which DES permutation or rotation is desired to be performed, an operand identifier which specifies a general-purpose register where the DES permutation or rotation operation's input is stored, and a destination identifier which specifies a general-purpose register where the DES permutation or rotation operation's output is to be stored.

2. The processor of claim 1, wherein the permutation-rotation identifier indicates that one of the following DES permutations is desired to be performed:
an initial permutation;
a key permutation for encryption;
a key permutation for decryption; or
a final permutation.

3. The processor of claim 1, wherein the permutation-rotation identifier indicates that one of the following DES rotations is desired to be performed:
a rotation by one to the left;
a rotation by two to the left;
a rotation by one to the right; or
a rotation by two to the right.

4. The processor of claim 1, wherein the execution unit comprises:
a set of circuit blocks configured to perform DES permutations; and
a multiplexer configured to use one or more bits of the permutation-rotation identifier to select a circuit block's output.

5. The processor of claim 1, wherein the execution unit comprises:
a set of circuit blocks configured to perform DES rotations; and
a multiplexer configured to use one or more bits of the permutation-rotation identifier to select a circuit block's output.

6. The processor of claim 1, wherein the execution unit supports a round instruction which includes an opcode which indicates that a DES round operation is desired to be performed, a first operand identifier which specifies a general-purpose register where the DES round operation's text input is stored, a second operand identifier which specifies a general-purpose register where the DES round operation's key input is stored, and a destination identifier which specifies a general-purpose register where the DES round operation's output is to be stored.

7. The processor of claim 6, wherein the execution unit includes:
a first circuit block configured to perform an expand operation and a first permutation operation;
a second circuit block configured to perform a first exclusive-OR operation;
a third circuit block configured to perform a look-up table operation;
a fourth circuit block configured to perform a second permutation operation; and
a fifth circuit block configured to perform a second exclusive-OR operation and a concatenation operation.

8. The processor of claim 7, wherein the third circuit block uses combinational logic, instead of read-only memory, to perform the look-up table operation.

9. A processor, comprising:
a set of general-purpose registers, wherein each general-purpose register is at least 64 bits wide; and
an execution unit which supports a round instruction which includes an opcode which indicates that a Data Encryption Standard (DES) round operation is desired to be performed, a first operand identifier which specifies a general-purpose register where the DES round operation's text input is stored, a second operand identifier which specifies a general-purpose register where the DES round operation's key input is stored, and a destination identifier which specifies a general-purpose register where the DES round operation's output is to be stored.

10. The processor of claim 9, wherein the execution unit includes:
a first circuit block configured to perform an expand operation and a first permutation operation;
a second circuit block configured to perform a first exclusive-OR operation;
a third circuit block configured to perform a look-up table operation;
a fourth circuit block configured to perform a second permutation operation; and
a fifth circuit block configured to perform a second exclusive-OR operation and a concatenation operation.

11. The processor of claim 10, wherein the third circuit block uses combinational logic, instead of read-only memory, to perform the look-up table operation.

12. A processor, comprising:
a set of general-purpose registers, wherein each general-purpose register is at least 64 bits wide; and
an execution unit which supports one or more Data Encryption Standard (DES) instructions for performing DES operations, wherein each DES instruction inputs at most two operands from the set of general-purpose registers, and outputs exactly one result to the set of general-purpose registers, and wherein the DES instructions enable DES encryption or DES decryption to be performed in fewer than 35 instruction executions.

13. The processor of claim 12, wherein the one or more DES instructions includes a permutation-rotation instruction which includes an opcode which indicates that a DES permutation or rotation operation is desired to be performed, a permutation-rotation identifier which specifies which DES permutation or rotation is desired to be performed, an operand identifier which specifies a general-purpose register where the DES permutation or rotation operation's input is stored, and a destination identifier which specifies a general-purpose register where the DES permutation or rotation operation's output is to be stored.

14. The processor of claim 13, wherein the permutation-rotation identifier indicates that one of the following DES permutations is desired to be performed:
an initial permutation;
a key permutation for encryption;
a key permutation for decryption; or
a final permutation.

15. The processor of claim 13, wherein the permutation-rotation identifier indicates that one of the following DES rotations is desired to be performed:
a rotation by one to the left;
a rotation by two to the left;
a rotation by one to the right; or
a rotation by two to the right.

16. The processor of claim 13, wherein the execution unit comprises:
a set of circuit blocks configured to perform DES permutations; and
a multiplexer configured to use one or more bits of the permutation-rotation identifier to select a circuit block's output.

17. The processor of claim 13, wherein the execution unit comprises:
a set of circuit blocks configured to perform DES rotations; and
a multiplexer configured to use one or more bits of the permutation-rotation identifier to select a circuit block's output.

18. The processor of claim 12, wherein the one or more DES instructions includes a round instruction which includes an opcode which indicates that a DES round operation is desired to be performed, a first operand identifier which specifies a general-purpose register where the DES round operation's text input is stored, a second operand identifier which specifies a general-purpose register where the DES round operation's key input is stored, and a destination identifier which specifies a general-purpose register where the DES round operation's output is to be stored.

19. The processor of claim 18, wherein the execution unit includes:
a first circuit block configured to perform an expand operation and a first permutation operation;
a second circuit block configured to perform a first exclusive-OR operation;
a third circuit block configured to perform a look-up table operation;
a fourth circuit block configured to perform a second permutation operation; and
a fifth circuit block configured to perform a second exclusive-OR operation and a concatenation operation.

20. The processor of claim 19, wherein the third circuit block uses combinational logic, instead of read-only memory, to perform the look-up table operation.
